(19) United States
(12) Patent Application Publication
(10) Pub. No.: US 2009/0300833 A1
(43) Pub. Date: Dec. 10, 2009

(54) FLAME RESISTANT, SELECTIVELY PERMEABLE LAMINATES

(75) Inventors: William George Kampert, Wilmington, DE (US); Bryan Benedict Sauer, Boothwyn, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. duPont de Nemours and Company, Wilmington, DE (US)

(21) Appl. No.: 12/135,266

(22) Filed: Jun. 9, 2008

(51) Int. Cl. A62B 17/00; D06M 17/00; B32B 27/34

(52) U.S. Cl. 2/458; 428/474.4; 442/147; 428/305.5; 2/81

(57) ABSTRACT

Flame resistant, selectively permeable laminates are provided. In various embodiments, the laminates are useful for fabrication as a protective article and are both flame resistant and substantially impermeable to hazardous chemical and biological agents, but sufficiently permeable to water vapor that, if worn as protective apparel, it is both protective and comfortable to wear.

### TECHNICAL FIELD

The present invention relates to processes for preparing selectively permeable, flame resistant laminates from continuous chitosan films. In various embodiments, the laminates are useful for fabrication as a protective article and are substantially impermeable to hazardous chemical and biological agents, but sufficiently permeable to water vapor that, if worn as protective apparel, it is both protective and comfortable to wear.

### BACKGROUND

There is a growing need for structures that provide personal protection against toxic chemical and biological agents. It is known to devise structures that are impermeable to toxic chemical vapors and liquids, but, when used as apparel, such structures are typically also hot, heavy and uncomfortable to wear.

The degree of comfort offered by apparel worn as a protective suit is significantly affected by the amount of water vapor that can permeate through the fabric from which the suit is made. The human body continuously perspires water as a method for controlling body temperature. When a protective fabric hinders the loss of water vapor from the body, the transpirational cooling process is hindered, which leads to personal discomfort. When a protective suit allows little or no loss of water vapor, extreme heat stress or heat stroke can result in a short period of time. Hence, it is desirable that, in addition to offering the highest levels of protection against toxic chemicals and liquids, a practical chemical and biological protective suit should have high water vapor transmission rates. It is also desirable that the appropriate protective structure be light in weight and offer the same high level of protection over a long period of time. Copending U.S. patent application Ser. No. 11/593,958, filed Nov. 7, 2006, discloses laminates made from chitosan films, which provide impermeability to hazardous chemical and biological agents and permeability to water vapor that, suitable for protective apparel.

However, it is desirable for applications such as fire fighter turn out gear that the protective structure be adequately flame resistant. S. Charuchinda et al (J. Sci. Res. China Univ., (2005), 30(1), 97-107) showed that applying a chitosan solution to cotton fabric improved neither LOI (limiting oxygen index) nor ignitability, though flame spread rate was lowered slightly.

The present invention provides flame resistant, selectively permeable laminates that contain a continuous chitosan film and that can be used in articles for personal protection, providing improved wearer comfort compared with impermeable articles.

### SUMMARY OF THE INVENTION

One aspect of the present invention is a flame resistant, selectively permeable protective structure comprising a continuous chitosan film and two layers of aramid fabric, wherein the continuous chitosan film is interposed between the two layers of aramid fabric.

Another aspect of the present invention is a finished article incorporating a flame resistant, selectively permeable laminate comprising a continuous chitosan film and two layers of aramid fabric, wherein the continuous chitosan film is interposed between the two layers of aramid fabric.

These and other aspects of the present invention will be apparent to one skilled in the art in view of the following description and the appended claims.

### BRIEF DESCRIPTION OF THE DRAWINGS

FIG. 1 is a schematic diagram showing the structure of one type of flame resistant, selectively permeable laminate according to an embodiment of the present invention.

### DETAILED DESCRIPTION

The present inventors have found that desirable flame resistance can be obtained in films comprising a continuous chitosan film interposed between two layers of aramid fabric.

In the context of this disclosure, a number of terms shall be utilized.

The term “flame resistant” as used herein denotes an article that meets the passing requirements of NFPA 1971 specification for fire fighter turnout gear; i.e., in the ASTM D6413 vertical flame test, the char length must be less than 4″ (10.1 cm) and afterflame must be less than 2 seconds, with no melt or drip.

The term “film” as used herein means a thin but discrete structure that moderates the transport of species in contact with it, such as gas, vapor, aerosol, liquid and/or particulates. A film may be chemically or physically homogeneous or heterogeneous. Films are generally understood to be less than about 0.25 mm thick.

The term “sheet” as used herein means a film that is at least 0.25 mm thick.

Unless otherwise stated or apparent by the particular context, the term “chitosan” as used herein includes chitosan-based moieties including chitosan itself, chitosan salts, and chitosan derivatives.

The term “chitosan film” as used herein means a film that contains at least one chitosan-based moiety in the amount of at least 50% by weight.

The term “nonporous” as used herein denotes a material or surface that does not allow the passage of air other than by diffusion.

The term “continuous chitosan film” as used herein means a chitosan film having at least one nonporous surface.

The term “permeable” as used herein means allowing liquids or gases to pass or diffuse through.

The term “selectively permeable” as used herein means allowing passage of certain species but acting as a barrier to others.

The term “laminate” as used herein means a material comprising two or more parallel layers of material that are at least partially bonded to each other. The term “prelaminate” denotes a laminated structure, typically a layer of fabric and an adherent film that will be used in the construction of other laminates.

The term “substrate” as used herein means the material onto which a film is formed from solution.

The term “work device” as used herein denotes a substrate which is used only for film formation and does not subsequently become part of a laminate.

The term “soluble” as used herein denotes a material that forms a visibly transparent solution when mixed with a specified solvent. For example, a water-soluble material forms a transparent solution when mixed with water, while a water-insoluble material does not.

The term “chitosan solution” as used herein indicates that at least one chitosan moiety is dissolved in the indicated solvent. However, materials that are insoluble in the indicated solvent may also be present.

The term “solubilize” as used herein means to render a material soluble in a specified solvent.

The term “harmful to human health” as used herein means causing injury to humans as a consequence of acute or chronic exposure through dermal contact, ingestion, or respiration.

The laminates described herein are flame resistant, according to this standard, despite the fact that the chitosan films themselves, as well as the polyurethane layers and adhesives commonly used in these laminates, are flammable. A laminate of aramid fabric/adhesive dots/thermoplastic polyurethane film/adhesive dots/aramid fabric fails the ASTM D6413 vertical flame test, yet a laminate made from the same components but now including a chiotsan film, i.e., aramid fabric/adhesive dots/thermoplastic polyurethane film/chitosan film/thermoplastic polyurethane film/adhesive dots/aramid fabric, passes the flame resistance test.

In preferred embodiments, the laminates described herein are both flame resistant and substantially impermeable to certain biological and/or chemical agents. It is often desirable that the laminates be at least 99% impermeable to certain agents, even up to 100% impermeable.

In one embodiment, the present invention provides a protective structure, fabricated from a flame resistant, selectively permeable laminate containing a continuous chitosan film. The structures can be used in articles and items of apparel that protect against exposure to a chemical or biological agent that is harmful to human health. Specific embodiments include finished articles, including articles of apparel, fabricated from a flame resistant, selectively permeable laminate containing a continuous chitosan film.

In another embodiment, the invention provides a method for increasing the flame resistance of a laminate comprising two layers of aramid fabric and a flammable adhesive, or an article or item of apparel fabricated therefrom, by interposing between the two layers of aramid fabric within the laminate a continuous chitosan film.

Because the laminates are both flame resistant and selectively permeable, we have found that a structure fabricated therefrom provides a protective barrier that inhibits the permeation through the laminate, and thus through the structure, of chemical and biological agents that may be harmful to humans while maintaining sufficient water vapor permeability to maintain personal comfort and providing protection against fire when the laminate is used to fabricate an item of apparel.

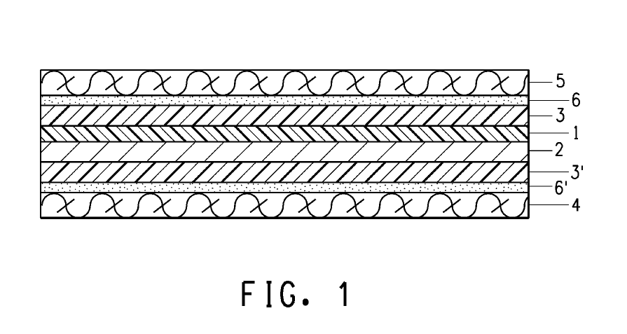

The flame resistant, selectively permeable laminates described herein contain a continuous chitosan film. In one embodiment, the chitosan film is deposited from solution onto a substrate. In another embodiment, a chitosan film adhered to a substrate, for example, polyurethane film, by thermal bonding. This continuous chitosan film, or a chitosan film cast onto a substrate, or a chitosan film thermally bonded to another layer, is interposed between two layers of aramid fabric and bonded to the fabric layers by adhesive, thereby forming a flame resistant, selectively permeable laminate. The adhesive can be in the form of stripes or, preferably, dots, to provide a discontinuous layer of adhesive, in order not to block passage of gases and/or liquids through the selectively permeable laminate. FIG. 1 illustrates one embodiment of a flame resistant, selectively permeable laminate that could be used in, for example, an article of apparel. In the embodiment shown, the laminate contains the following elements: a continuous chitosan film (1); a substrate to which the continuous chitosan film is adhered (2); additional protective and/or adhesive films (3, 3′); an inner aramid fabric liner (4); an outer shell of aramid fabric (5) and adhesive (6).

### Continuous Chitosan Film

Chitosan is the commonly used name for poly-[1-4]-β-D-glucosamine. It is commercially available and is chemically derived from chitin, which is a poly-[1-4]-β-N-acetyl-D-glucosamine that, in turn, is derived from the cell walls of fungi, the shells of insects and, especially, crustaceans. In the preparation from chitin, acetyl groups are removed, and, in the chitosan used herein, the degree of deacetylation is at least about 60%, and is preferably at least about 85%. As the degree of deacetylation increases, it becomes easier to dissolve chitosan itself in acidic media.

Suitable chitosan-based moieties include chitosan itself, chitosan salts, and chitosan derivatives. Representative examples of chitosan derivatives suitable for use in this invention include N- and O-carboxyalkyl chitosan. The number average molecular weight (Mₙ) in aqueous solution of the chitosan used herein is at least about 10,000.

A chitosan film may be cast from solution. If it is desired to cast a chitosan film from an aqueous solution, however, the chitosan is first solubilized, since chitosan itself is not soluble in water. Preferably, solubility is obtained by adding the chitosan to a dilute solution of a water-soluble acid. This allows the chitosan to react with the acid to form a water-soluble salt, herein referred to as a “chitosan salt” or “chitosan as the (acid anion) thereof”, for example “chitosan as the acetate thereof” if acetic acid was used. Chitosan derivatives such as N- and O-carboxyalkyl chitosan that are water-soluble can be used directly in water without the addition of acid.

The acid used to solubilize the chitosan may be inorganic or organic. Examples of suitable inorganic acids include without limitation hydrochloric acid, sulfamic acid, hot sulfuric acid, phosphoric acid and nitric acid. Suitable organic acids may be selected from the group consisting of water-soluble mono-, di- and polycarboxylic acids. Examples include without limitation formic acid, acetic acid, pimellic acid, adipic acid, o-phthalic acid, and halogenated organic acids. Other suitable acids are disclosed in U.S. Pat. No. 2,040,880. Mixtures of acids may also be used. Volatile acids, that is, those with a boiling point less than about 200° C., are preferred.

The amount of acid used to solubilize the chitosan can be chosen to control the viscosity. If too little acid is added, the resulting solution may be too viscous to cast a thin film and/or to be filtered. The desired amount of acid used will also depend on the desired chitosan concentration in the final solution. It will depend as well on the molecular weight and degree of deacetylation of the starting chitosan, since those properties determine the molar concentration of amino groups (—NH₂) available to react with the acid. Preferably, about one acid equivalent is added per mole of chitosan amino group (—NH₂).

The appropriate concentration of chitosan in the final solution will vary depending on how the solution is to be applied, and also on the molecular weight of the chitosan, as a lower concentration may be desired for a relatively high molecular weight chitosan. Different application methods work best with solutions of different viscosities, but typically, the solution will contain from about 0.1 to about 15 wt % chitosan, based on the total combined weight of the solution and the chitosan.

The chitosan solution from which the film is prepared may include inorganic fillers, including without limitation, glass spheres, glass bubbles, clays (e.g., sepiolite, attapulgite, and montmorillonite) and the like. Small amounts of such fillers, preferably less than 10 wt %, could be used to increase thermal stability, modulus, and barrier properties of the chitosan film where this is desirable. The chitosan solution from which the film is prepared may also include flame retardants for additional enhancement of flame resistance. The additives (inorganic fillers and/or flame retardants) are present at less than 50% by weight, based on the weight of chitosan plus additives.

A chitosan film may be prepared by casting a chitosan solution directly onto a substrate that will be incorporated along with the film into a laminate. Alternatively, the chitosan solution may be cast onto a work device such as a smooth surface, such as glass or a polymer film (for example, polyester film). If the film is cast onto a work device, the film is then dried, detached and then incorporated into a laminate in a separate step.

The solution may be applied to a substrate by any of a variety of methods known in the art. For a small scale process, such as a laboratory test sample, the solution is typically applied using a doctor knife. Methods available to coat surfaces which are planar and have irregular surfaces include without limitation spray coating, dip coating, and spin coating. In a commercial process, the solution could be applied to, e.g., traveling web using methods that include without limitation reverse roll, wire-wound or Mayer rod, direct and offset gravure, slot die, blade, hot melt, curtain, knife over roll, extrusion, air knife, spray, rotary screen, multilayer slide, coextrusion, meniscus, comma and microgravure coating. These and other suitable methods are described by Cohen and Gutoff in “Coating Processes” in the Kirk-Othmer Encyclopedia of Chemical Technology [John Wiley & Sons, 5^{th} edition (2004), Volume 7, Pages 1-35]. The method chosen will depend on several factors, such as the rheology of the solution to be applied, the desired wet film thickness, the speed of a substrate that is traveling, and the required coating accuracy as a percent of total thickness.

The applied solution is then dried by any suitable means known in the art such as exposure to a hot air oven, air impingement drying, or radiative (e.g. infrared or microwave) drying (See, generally, Cohen and Gutoff, op. cit.). The result of the drying at this stage is a continuous film. If the chitosan is dissolved in an aqueous solution of a volatile acid, that is, an acid whose boiling point is less than about 200° C., exposure to ambient air may be sufficient for drying, and drying will remove acid as well as water.

If a film at this stage is water-soluble, it can be made water-insoluble by heating; by reacting it with a crosslinking reagent; by treatment with a strong base; or by a combination of two or more of these methods. For example, a film cast from a formic acid solution can be made water-insoluble by heat treatment after the film has been formed and dried, for example, by heating at about 100° to about 260° C. for about 0.1 to about 60 minutes, or more preferably about 100° C. to 180° C. for about 1 to 10 minutes. Heat treatment plus the use of a crosslinking agent could also be used to render the chitosan film insoluble.

The film can also be made insoluble by adding any of a variety of crosslinking agents to a solution before a film is cast therefrom. A crosslinking agent is a reactive additive that creates bonds, i.e. crosslinks, between polymer chains. Examples of crosslinking agents for chitosan include without limitation glutaraldehyde (J. Knaul et al., Advances in Chitin Science (1998), 3 399-406) and epichlorohydrin (U.S. Pat. No. 5,015,293). With these additives, temperatures of about 100° C.-120° C. for about 1 to 10 minutes can cause insolubility. Crosslinking agents may also be applied to the film after it is dried.

The film can also be made water-insoluble by contacting the film with a base and then washing, which converts the film from the chitosan salt form to free chitosan. If the film to be treated with base is attached to a substrate, the composition and concentration of the base will be influenced by the nature of the substrate (e.g., its reactivity toward base) and processing conditions (e.g., temperature and contact time, continuous versus batch process). Typically, the base is a 1% to 10% by weight aqueous solution of sodium hydroxide, and typical contact times are 30 seconds to 3 hours at ambient temperature. Heat treatment plus contact with base could also be used to render the film insoluble.

### Substrate Materials

The chitosan film can be adhered to a substrate. Referring to FIG. 1, a chitosan film 1 may be prepared by casting a chitosan solution directly onto a substrate 2 that will be incorporated along with the film into a laminate. It can also be cast on a work surface like PET film and coated with an additional layer or layers before or after the work surface is removed and discarded. In certain cases, the substrate onto which a chitosan film may be prepared may itself be a continuous sheet or film, provided that the permeability of the substrate to water vapor under use conditions is adequate for the particular end use. For example, a garment would require much higher water vapor permeability than a tent or tarpaulin.

A suitable substrate will have at least one surface that is smooth, i.e., essentially without protrusions above the plane of the substrate that are higher than the desired thickness of the coating of chitosan that will be transformed into the film. Thus, a smoother substrate surface is required when the desired thickness of the coating of chitosan is 25 μm than when it is 100 μm.

A suitable substrate may be, for example, a film, a sheet whose permeability to water vapor under use conditions is adequate for the particular end use, a microporous membrane (i.e., one in which the typical pore size is about 0.1 to 10 μm in diameter), or an article prepared from any of the foregoing. It is preferred that the substrate surface that will be in contact with the chitosan film be both smooth and nonporous. Examples of suitable substrate materials include without limitation Nafion® perfluorosulfonic acid tetrafluoroethylene copolymers (e.g., tetrafluoroethylene/perfluoro(4-methyl-3,6-dioxa-7-octene-1-sulfonic acid) copolymer, CA Registry Number 31175-20-9, available from E. I. du Pont de Nemours & Company, Inc., Wilmington, Del., USA), polyurethanes (e.g., polyurethane films available from Omniflex Co., Greenfield, Mass., USA), polyether block polyamide copolymers (e.g., Pebax® polyether block amides available from Arkema, Paris, France), and polyether block polyester copolymers. (e.g., Hytrel® thermoplastic polyester elastomers available from E. I. du Pont de Nemours & Company, Inc).

### Fabric Layers

The protective laminates described herein comprise a continuous chitosan film interposed between two layers of aramid fabric.

An aramid is an aromatic polyamide, wherein at least 85% of the amide (—CONH—) linkages are attached directly to two aromatic rings. A suitable aramid may be in the form of a copolymer that may have as much as 10 percent of other diamine(s) substituted for the diamine of the aramid or as much as 10 percent of other diacid chloride(s) substituted for the diacid chloride of the aramid. A m-aramid would be preferred in a fabric as used in this invention, and poly(m-phenylene terephthalamide) (MPD-I) is the preferred m-aramid. P-aramids may also find use in the present invention, and poly (p-phenylene isophthalamide) (PPD-T) is the preferred m-aramid. P-aramid and m-aramid fibers and yarns particularly suitable for use in the present invention are those sold respectively under the trademarks Kevlar® and Nomex® (E. I. du Pont de Nemours and Company, Wilmington Del., USA), and Teijinconex®, Twaron® and Technora® (Teijin Ltd., Osaka, Japan), and equivalent products offered by others.

### Fabrication

The flame resistant, selectively permeable laminates described herein can be assembled using any of the adhering operations, such as thermally pressing, known in the art.

Referring to FIG. 1, the layers to be assembled include the chitosan film 1 and at least two layers of aramid fabric (4 and 5). For example, if the chitosan film is cast on a work device, the film is then dried and detached as a free-standing film. Other layers could be added either before or after detachment from the work device. It may then be attached to another layer (for example, substrate, outer shell, inner liner) using an adhesive such as a polyurethane-based adhesive. The adhesive may be present as a continuous layer, an array of adhesive dots, or in a number of alternative patterns such as lines or curves. The adhesive may be applied in a variety of ways including spraying or gravure roll.

To fabricate a structure or other article from a laminate disclosed herein, such as an item of apparel, the laminate may itself be sandwiched between (additional) woven fabrics. Bonding between the film structure and the fabrics may be continuous or semicontinuous, for example, with adhesive dots or films. Continuous bonding is preferred.

### Uses

The laminates described herein are selectively permeable, having a Moisture Vapor Transport Rate (“MVTR”) of at least 2 kg/m²/24 h, while the transport rate of materials harmful to human health is low enough to prevent the occurrence of injury, illness or death. The specific transport rate needed will necessarily depend on the specific harmful material; for example, NFPA 1994, 2006 Revision requires <4.0 μg/cm² one hour cumulative permeation for mustard and <1.25 μg/cm² for Soman, both of which requirements are met by the laminates and the continuous chitosan film it contains. Consequently, the laminates, as well as the continuous chitosan film itself, can be used for the fabrication of, or as a component in, a variety of articles of manufacture, including articles of protective apparel, especially for clothing, garments or other items intended to protect the wearer or user against harm or injury as caused by exposure to toxic chemical and/or biological agents, including without limitation those agents potentially used in a warfighter environment and materials identified as “Toxic Industrial Chemicals” (TICs) or “Toxic Industrial Materials” (TIMs); see, for example, Guide for the Selection of Chemical and Biological Decontamination Equipment for Emergency First Responders, NIJ Guide 103-00, Volume I, published by the National Institute of Justice, U.S. Department of Justice (October 2001), herein incorporated by reference. A few examples of TICs are phosgene, chlorine, parathion, and acrylonitrile. Permeability of the laminate or a layer in the laminate to specific substances may be determined by various methods including, without limitation, those described in ASTM F739-91, “Standard Test Method for Resistance of Protective Clothing Materials to Permeation by Liquids or Gases Under Conditions of Continuous Contact.”

In one embodiment, the item of apparel is useful to protect military personnel against dermal exposure to chemical and biological agents potentially encountered in a warfighter environment. Examples of such agents include without limitation nerve agents such as Sarin (“GB,” O-isopropyl methylphosphonofluoridate), Soman (“GD,” O-Pinacolyl methylphosphonofluoridate), Tabun (“GA,” O-Ethyl N,N-dimethylphosphoramidocyanidate), and VX (O-Ethyl S-2-diisopropylaminoethyl methylphosphonothiolate); vesicant agents such as sulfur mustards (e.g., Bis(2-chloroethyl)sulfide and Bis(2-chloroethylthio)methane); Lewisites such as 2-chlorovinyldichloroarsine; nitrogen mustards such as Bis-(2-chloroethyl)ethylamine (“HN1”); tear gases and riot control agents such as Bromobenzyl cyanide (“CA”) and Phenylacyl chloride (“CN”); human pathogens such as viruses (e.g., encephalitis viruses, Ebola virus), bacteria (e.g., Rickettsia rickettsii, Bacillus anthracis, Clostridium botulinum), and toxins (e.g., Ricin, Cholera toxins). A human pathogen is a microorganism that causes disease in humans.

In a further embodiment, the item of apparel is useful to protect first responder personnel from known or unknown chemical or biological agents potentially encountered in an emergency response situation. In yet another embodiment, the item is intended to protect cleanup personnel from chemical or biological agents during a hazmat response situation. Examples of hazardous material in addition to those listed above include certain pesticides, particularly organophosphate pesticides.

The laminate is also flame resistant, in that it meets the passing requirements of NFPA 1971 specification for fire fighter turnout gear; i.e., in the ASTM D6413 vertical flame test, the char length must be less than 4″ (10.1 cm) and afterflame must be less than 2 seconds, with no melt or drip.

Such clothing, garments or other items that may be made using the laminates described herein include without limitation coveralls, protective suits, fire fighter turnout gear, coats, jackets, limited-use protective garments, gloves, socks, boots, shoe and boot covers, trousers, hoods, hats, masks, shirts, and medical garments.

In another embodiment, the laminates can be used to create a protective cover, such as a tarpaulin, or a collective shelter, such as a tent, that is both flame resistant and protective against chemical and/or biological warfare agents.

### EXAMPLES

Specific embodiments of the present invention are illustrated in the following examples. The embodiments of the invention on which these examples are based are illustrative only, and do not limit the scope of the appended claims.

The meaning of the abbreviations used in the examples is as follows: “s” means second(s), “min” means minute(s), “h” means hour(s), “kg” means kilogram(s), “g” means gram(s), “mg” means milligram(s), “μg” means microgram(s), “oz” means ounce(s), “yd” means yard(s), “mmol” means millimole(s), “m” means meter(s), “cm” means centimeter(s), “mm” means millimeter(s), “μm” means micrometer(s), “mL” means milliliter(s), “μL” means microliter(s), “M” means molar, “N” means normal, “wt %” means weight percent, “ppm” means parts per million, “MW” means molecular weight, “Mₙ” means number average molecular weight, “M_{w}” means weight average molecular weight, “ND” means not detected, “Pa” means Pascal, “kPa” means kilopascal, “psig” means pounds per square inch gage, “PU” means polyurethane, and “SEC” means size exclusion chromatography. Unless otherwise specified, the water used is distilled or deionized water.

The chitosan materials used in the following Examples were obtained from Primex Ingredients ASA, Norway under the trademark ChitoClear® chitosan. According to the manufacturer, Primex ChitoClear® TM-656 has a Brookfield viscosity of 26 cP (0.026 Pa·s, 1% chitosan in a 1% aqueous acetic acid solution). The Mn and Mw were determined by SEC to be 33,000 and 78,000, respectively.

### Methods

### Standard Chitosan Salt Solution Preparation

This method was used to prepare chitosan solutions for the examples unless otherwise noted. A food blender cup is preheated in a boiling water bath, placed on the blender's motor, and charged with 564 g of hot water and 36 g of chitosan (Primex ChitoClear® TM-656) (0.22 mole —NH₂). While stirring strongly, 11.5 g (0.25 mole) formic acid is added. The formic acid is of 98% purity and is obtained from Aldrich Chemical Company (Milwaukee, Wis.). The viscosity increases immediately. After three minutes of stirring, the resulting viscous mass is poured into a Pyrex® glass bottle and heated for 1 h in a boiling water bath. Afterward, it is pressure filtered through coarse filter paper. The solution is cleared of bubbles after standing for three days at room temperature.

### Standard Glass Plate Preparation.

When films are to be cast onto a work device such as a glass plate, it is important that the glass plate surface be clean. The following cleaning procedure was used for the examples, but any thorough cleaning procedure would be suitable. A Pyrex® glass plate is washed with PEX lab soap, rinsed with water, and wiped dry. The plate is then cleaned with methanol and, finally, coated and rubbed with 10 wt % aqueous NaOH solution and allowed to stand for ten minutes. The plate is ready for casting after a final rinse with water and drying with soft paper towels.

### Molecular Weight Determination.

The molecular weights of the chitosan samples are determined by size exclusion chromatography using a triple-detector aqueous system, consisting of a Waters 2690 separations module, a Wyatt-DAWN DSP multi-angular (18) light scattering detector, a Waters 410 differential refractometer (Waters Corporation, Milford, Mass., USA), and a Viscotek T60-B viscometer (Viscotek, Houston, Tex., USA). Two TSK-GEL GMPW columns (TOSOH Bioscience LLC, TOSOH Corporation, Tokyo, Japan) are used. The mobile phase is an aqueous solution of 0.3M acetic acid with 0.3M sodium acetate at a flow rate of 0.5 mL/min. The samples have been first dissolved for 4 hours in a shaker.

### Moisture Vapor Transmission Rate (MVTR).

This is measured by a method derived from the Inverted Cup method of MVTR measurement [ASTM E 96 Procedure BW, Standard Test Methods for Water Vapor Transmission of Fabrics (ASTM 1999)]. A vessel with an opening on top is charged with water and then the opening is covered first with a moisture vapor permeable (liquid impermeable) layer of expanded-PTFE film (“ePTFE”), and then with the sample for which the MVTR is to be measured, and finally by woven fabric overlayer [NYCO 50:50 nylon/cotton blend, 6.7 oz/yd² (0.23 kg m²) or Nomex® fabric, 5.6 oz/yd² (0.19 kg/m²), both treated with durable water repellant finish]. The three layers are sealed in place, inverted for 30 minutes to condition the layers, weighed to the nearest 0.001 g, and then contacted with a dry stream of nitrogen while inverted. After the specified time, the sample is re-weighed and the MVTR calculated (kg/m²/24 h) by means of the following equation:

MVTR=1/[(1/MVTR_{obs.})−(1/MVTR_{mb})]

where MVTR_{obs} is observed MVTR of the experiment and MVTR_{mb} is the MVTR of the ePTFE moisture barrier (measured separately). The reported values are the average of results from four replicate samples.

### Dimethylmethylphosphonate (“DMMP”) Permeation.

DMMP was used as a relatively non-toxic simulant for chemical warfare G-class nerve agents. The DMMP permeation for the examples described below was carried out as follows: a vessel with an opening on top was charged with a measured amount of water containing 0.100% propylene glycol as an internal GC standard. If the sample was a film, the opening was covered with the sample film and a woven fabric overlayer [NYCO 50:50 nylon/cotton blend, 6.7 oz/yd² (0.23 kg/m²) or Nomex®, 5.6 oz/yd² (0.19 kg/m²), both treated with durable water repellant finish] was placed on top of the film, and the layers are sealed in place. If the sample was a laminate that already had a fabric surface, no additional fabric overlayer was used. In both types of samples, the fabric surface was treated with one 2 μL drop of DMMP (2.3 mg). The vessel was placed in a nitrogen-purged box for 17 h and then the DMMP concentration in the water was measured by GC analysis. Results are reported in μg of DMMP measured in the water after 17 h and are the average of five replicate samples. The DMMP was obtained from Aldrich Chemical Company (Milwaukee, Wis.) and was used as received.

### Mustard and Soman Transmission Rates.

The military TOP-8-2-501 (dual flow method) was used to test 24 hour permeation against sulfur mustard, S(CH₂CH₂Cl)₂, and the nerve agent Soman. Alternatively, the NFPA 1994, 2006 revision was utilized to measure 1 hour permeation accumulation for the same two agents.

### Flame Resistance.

Flame resistance was determined according to ASTM D6413 (Standard Test Method for Flame Resistance of Textiles—Vertical Method). Specifically, ASTM D6413 allows determination of char length, after-flame time, and afterglow time.

The ASTM method stipulates a sample dimension of 3″ (7.6 cm) by 12″ (30 cm) held vertically by metal clamps in a draft free chamber. A 1.5″ (3.8 cm) methane flame from a Bunsen burner was placed underneath the middle of the suspended fabric so that the tip of the flame is 0.75″ (1.9 cm) up from the bottom edge. It was applied for 12 seconds and then removed. The after-flame time (visible flame after 12 second exposure) and the afterglow time (visible glow of material after 12 second exposure or cessation of flaming) were recorded. After the sample had cooled, it was removed from the chamber and the amount of char was measured as follows. The sample was creased in the middle, folding the sample in half along the crease. Then a hole was punched in one corner by the end where the sample was exposed to the flame. A 100 gram weight was hung from the hole and the other corner grasped. The sample was raised until the weight just left its resting surface. The crack length was then measured to the nearest 0.12 inch (0.30 cm).

### Example 1

Example 1 illustrates the preparation and barrier properties of a laminate that comprises a chitosan film between two layers of aramid fabric.

Two prelaminates, 1A and 1B, were prepared as follows:

1A: Nomex pajamacheck fabric (woven, 3.3 oz/yd², 0.11 kg/m²) was bonded to monolithic polyurethane (PU) film (5-10 μm thick) with polyurethane adhesive dots (25% coverage).

1B: Nomex knit fabric (1.5 oz/yd², 51 g/m²) was bonded to polyurethane (PU) film (5-10 μm thick) with polyurethane adhesive dots (25% coverage).

A chitosan film (Primex ChitoClear® TM-656) was prepared from a standard chitosan salt solution as follows: Chitosan (20 g; 120 mmol) was added to a rapidly stirred solution of formic acid (6.6 g; 120 mmol) in water (380 g). The viscous mass in a bottle was shaken and then rolled on a roll mill for 1 h and then pressure filtered through coarse filter paper. Films were cast from the resulting solution with a 30 mil (0.75 mm) doctor knife onto a flat Pyrex glass plate, dried at 90 C and then treated with 10% NaOH aqueous solution for about 2 minutes. The washed and dried film was removed from the glass by raising the edges of the film from the glass with a razor blade, then pulling the film cautiously from the glass. The thickness of the film was about 30 μm. A sample of the film was heat laminated (130 C for 45 s at 125 psig (862 kPa)) between prelaminates 1A and 1B, with the PU film facing the chitosan in each case, thereby forming a laminate. These samples, with prelaminate 1A oriented upwards, were then overlaid with (but not laminated to) an outer shell of 7.5 oz/yd² (0.25 kg/m²) ripstop polybenzimidazole (“PBI”)/para-aramid fiber blend (available from Southern Mills, Inc. under the Gemini trademark).

Samples cut from the resulting structure were submitted for sulfur mustard [S(CH₂CH₂Cl)₂] and the nerve agent Soman permeation measurements under NFPA 1994, 2006 Revision testing protocol. The 1 h accumulated permeation for mustard for three replicates was ND (“not detected”), ND, 0.045, (g/cm²) and for Soman for two replicates, 0.018 and 0.090 (μg/cm²), all passing the NFPA 1994, 2006 Revision requirements of <4.0 μg/cm² one hour cumulative permeation for mustard and <1.25 μg/cm² for Soman.

### Example 2

The following three structures (“prelaminates”) were prepared in the same manner as Samples 1A and 1B:

Prelam1: is 6 oz/yd² (0.20 kg/m²) Nomex® fabric/thermoset polyurethane dots/6 μm thick thermoplastic polyurethane cap adhesive layer.

Prelam2 is 3.3 oz/yd² (0.11 kg/M²) Nomex® Pajama Check Jersey/thermoset polyurethane dots/6 μm thick thermoplastic polyurethane cap adhesive layer.

Prelam 3 is 1.5 oz/yd² (51 g/m²) Nomex® Pajama Check Jersey/thermoset polyurethane dots/6 μm thick thermoplastic polyurethane cap adhesive layer.

Chitosan films, 25″ (0.64 m) in width, 0.6 mil (15 μm) dry thickness, were prepared by casting 0.6% aqueous acetic acid solution containing 5% chitosan by weight (Primex ChitoClear® TM-656), pre-filtered through 20 μm filters, onto a 3 mil (75 um) poly(ethylene terephthalate) casting substrate with a modified Worldwide Magnetic Tape Ram slot die coater. They were heated to 130° C., and then peeled off the work surface.

Laminates were then made as described above from the 15 μm thick chitosan film and Prelams 1, 2, and 3 as indicated in Table 1. The assembled laminate components were melt pressed at 130 to 180° C. Each side of the chitosan film was adhered to the adhesive (cap) layer of a prelam. Flame resistance was determined according to ASTM D6413 as described above. All of the laminates met the passing requirements of the specification for fire fighter turnout gear.

TABLE 1

| | | After | After | |
|---|---|---|---|---|
| | Char | flame | glow | Pass/ |
| Sample Description | Length | (s) | (s) | Fail |
| Prelam1/15 μm | 2″ | 0 | 1 | Pass |
| Chitosan/Prelam3 | (5.1 cm) | | | |
| Prelam1/15 μm Chitosan/ | 2″ | 0.7 | 0 | Pass |
| Prelam3 (Repeat) | (5.1 cm) | | | |
| Prelam2/15 μm Chitosan/ | 3.75″ | 1 | 1 | Pass |
| Prelam3 | (19.0 cm) | | | |

### Comparative Example A

The flame resistance of the components of the laminates prepared in Example 2 (i.e., prelams 1, 2, and 3 and the 15 μm chitosan film) was determined according to ASTM D6413 as described above. As shown in Table 2, all failed to meet the passing requirements of NFPA 1971 specification for fire fighter turnout gear.

TABLE 2

| | | After | After | |
|---|---|---|---|---|
| Sample | | flame | glow | Pass/ |
| Description | Char Length | (s) | (s) | Fail |
| Prelam1 | 4.5″ (11 cm) | 1 | 0 | Fail |
| Prelam2 | >6″ (>15 cm | 28.7 | 2 | Fail |
| Prelam3 | >6″ (>15 cm | 0 | 0 | Fail |
| 15 μm Chitosan | * | * | * | Fail |
| film | | | | |

* Burned completely

### Comparative Example B

Two laminates were prepared, as described above, one from Prelam1 and Prelam3 and one from Prelam2 and Prelam3, both without chitosan film. The flame resistance of the laminates was determined according to ASTM D6413 as described above. As shown in Table 3, both failed to meet the passing requirements of NFPA 1971 specification for fire fighter turnout gear.

TABLE 3

| | | After | After | |
|---|---|---|---|---|
| Sample | Char | flame | glow | Pass/ |
| Description | Length | (s) | (s) | Fail |
| Prelam1/Prelam3 | 2.5″ (6.4 cm) | 30 | 0 | Fail |
| Prelam2/Prelam3 | >6″ (>15 cm) | 32 | 1 | Fail |

Examples 3 and 4 illustrate the preparation and performance of laminates containing continuous chitosan film and Nafion® PFSA film.

### Example 3

Chitosan films, 25″ (0.64 m) width, 1.2-1.4 mil (30 μm-36 μm) thick, were prepared by casting 0.6% aqueous acetic acid solution containing 4.2% chitosan by weight (Primex ChitoClear® TM-656), pre-filtered through 10 μm filters, onto a Nafion® PFSA substrate with a modified Worldwide Magnetic Tape Ram slot die coater. Chitosan films were cast onto commercial 1.0 mil (25 μm) Gen 1 and Gen 2 CS Nafion® films available from E. I. du Pont de Nemours and Company (Wilmington, Del., USA). The resulting chitosan/Nafion® PFSA films demonstrated good thickness uniformity with a smooth, even surface. Permeation values using a Nomex overlayer were MVTR, 38.6 kg m²/24 h and DMMP permeation, 0 μg in 17 h.

A chitosan/Nafion® PFSA structure so prepared was bonded to Nomex® fabric (woven, 5.6 oz/yd², 0.19 kg/m²) with polyurethane adhesive dots (25% coverage). The Nafion® side of the structure was bonded to Nomex® Jersey fabric (1.3 oz/yd², 44 g/m²) with polyurethane adhesive dots (25% coverage) to produce the final laminate: Nomex® fabric (woven)/adhesive dots/chitosan/Nafion®/adhesive dots/Nomex® Jersey fabric. The laminate was then baked at 160° C. in air for 2 minutes. MVTR was 30 kg/m²/24 h and DMMP permeation was 2 μg in 17 h.

### Example 4

A laminate was prepared from Prelam 1, a 6 μm thick film of chitosan that was cast onto a 19 μm thick film of Nafion® PFSA, and Prelam 3, as indicated in Table 4. The chitosan surface was adhered to the adhesive (cap) layer of Prelam 1, and the Nafion® PFSA surface was adhered to the adhesive (cap) layer of Prelam 3. The flame resistance of the laminate was determined according to ASTM D6413 as described above. As shown in Table 4, it met the passing requirements of NFPA 1971 specification for fire fighter turnout gear.

TABLE 4

| | | After | After | |
|---|---|---|---|---|
| | | flame | glow | |
| Sample Description | Char Length | (s) | (s) | Pass/Fail |
| Prelam1/6 μm Chitosan/19 μm | 1.5″ (3.8 cm) | 1 | 1 | Pass |
| Nafion ®/Prelam3 | | | | |

### Comparative Example C

Polymers such as PTFE are known to have at least some flame resistant properties, and a layer of expanded PTFE microporous film is a component in some fire fighter turnout gear. Comparative Example C demonstrates that when a microporous expanded PTFE film is incorporated into a Nomex® laminate in place of a chitosan film, the laminate fails the flame test, even though the chitosan film by itself is much more flammable than the expanded PTFE film.

A laminate was prepared in the manner described in Example 1 from Prelam2, a 20 μm thick film of expanded PTFE, and Prelam3, as indicated in Table 5. The flame resistance of the laminate was determined according to ASTM D6413 as described above. As shown in Table 5, it failed to meet the passing requirements of NFPA 1971 specification for fire fighter turnout gear.

TABLE 5

| | | After | After | |
|---|---|---|---|---|
| | Char | flame | glow | Pass/ |
| Sample Description | Length | (s) | (s) | Fail |
| Prelam2/20 μm | 5.5″ | 45.6 | 0 | Fail |
| expanded PTFE/ | | | | |
| Prelam3 | | | | |

### Comparative Example D

Polyimide films, such as Kapton® polyimide film, produce char when burned and are stable at high temperatures, having a melting point great than 500 C. These properties would lead one to expect such a film to perform better than the much more flammable chitosan film when incorporated in a Nomex® laminate. Comparative Example D demonstrates that when a Kapton® polyimide film is incorporated into a Nomex® laminate in place of a chitosan film, the laminate fails the flame test, even though the chitosan film by itself is much more flammable than the Kapton® polyimide film.

A laminate was prepared in the manner described in Example 1 from Prelam2, an 18 μm thick film of Kapton® polyimide, and Prelam3, as indicated in Table 6. The flame resistance of the laminate was determined according to ASTM D6413 as described above. As shown in Table 6, it failed to meet the passing requirements of NFPA 1971 specification for fire fighter turnout gear.

TABLE 6

| | | After | After | |
|---|---|---|---|---|
| | Char | flame | glow | Pass/ |
| Sample Description | Length | (s) | (s) | Fail |
| Prelam2/18 micron | 3.2″ | 28.2 | 0 | Fail |
| Kapton ®/Prelam3 | | | | |

Where an apparatus or method is stated or described herein as comprising, including, containing, having, being composed of or being constituted by certain components or steps, it is to be understood, unless the statement or description explicitly provides to the contrary, that one or more components or steps other than those explicitly stated or described may be present in the apparatus or method. Alternatively, an embodiment of an apparatus or method of this invention may be stated or described as consisting essentially of certain components or steps, indicating the absence of components or steps that would materially alter the principle of operation or the distinguishing characteristics of the apparatus or method. Further, if an apparatus or method is stated as consisting of certain components or steps, components or steps other than those as stated or described are not present therein.

Where the indefinite article “a” or “an” is used with respect to a statement or description of the presence of a component in an apparatus, or a step in a method, of this invention, it is to be understood, unless the statement or description explicitly provides to the contrary, that the use of such indefinite article does not limit the presence of the component in the apparatus, or of the step in the method, to one in number.

What is claimed is:

1. A flame resistant, selectively permeable protective structure comprising a continuous chitosan film and two layers of aramid fabric, wherein the continuous chitosan film is interposed between the two layers of aramid fabric.

2. The flame resistant, selectively permeable protective structure according to claim 1 wherein said structure is a laminate.

3. The flame resistant, selectively permeable structure according to claim 2 wherein the continuous chitosan film is adhered to a substrate.

4. The flame resistant, selectively permeable structure according to claim 3 wherein the substrate is selected from the group consisting of films, sheets, and microporous membranes.

5. The flame resistant, selectively permeable structure according to claim 4 wherein the substrate is a film or sheet comprising a polymer selected from the group consisting of perfluorosulfonic acid tetrafluoroethylene copolymers, polyurethanes, polyether block polyamide copolymers, and polyether block polyester copolymers.

6. The flame resistant, selectively permeable structure according to claim 1 wherein the Moisture Vapor Transport Rate is at least 2 kg/m²/24 h; the transport rate of at least one chemical or biological agent harmful to human health is low enough to prevent the occurrence of injury, illness or death caused by said chemical or biological agent; and in the ASTM D6413 vertical flame test, the char length is less than 10.1 cm, and afterflame is less than 2 seconds, with no melt or drip.

7. A finished article incorporating a flame resistant, selectively permeable laminate comprising a continuous chitosan film and two layers of aramid fabric, wherein the continuous chitosan film is interposed between the two layers of aramid fabric.

8. The finished article according to claim 7 wherein said article is selected from the group consisting of items of apparel, shelters, and protective covers.

9. An item of apparel according to claim 8 wherein the item of apparel is selected from the group consisting of coveralls, protective suits, coast, jackets, limited-use protective garments, gloves, socks, boots, shoe or boot covers, trousers, hoods, hats, masks, shirts and medical garments.

10. A method for increasing the flame resistance of a laminate comprising two layers of aramid fabric and a flammable adhesive, or an article or item of apparel fabricated therefrom, by interposing between the two layers of aramid fabric within the laminate a continuous chitosan film.
